(19) United States
(12) Patent Application Publication
(10) Pub. No.: US 2026/0292400 A1
(43) Pub. Date: Sep. 24, 2026

(54) WEARABLE AUDIO DEVICE MATERIAL COMPENSATION

(71) Applicant: Motorola Mobility LLC, Chicago, IL (US)

(72) Inventors: Wayne G. Morrison, Lake Zurich, IL (US); Nathan David Tipton, Chicago, IL (US); Sang Yup Lee, Round Lake, IL (US)

(73) Assignee: Motorola Mobility LLC, Chicago, IL (US)

(21) Appl. No.: 19/082,848

(22) Filed: Mar. 18, 2025

(51) Int. Cl. H04R 3/04

(52) U.S. Cl. CPC H04R 3/04

(57) ABSTRACT

Techniques for wearable audio device clothing compensation are described. In implementations, a direct interaction between a main body and a speaker accessory of a wearable device is detected. A baseline audio response from a speaker of the speaker accessory is measured and stored in response to detecting the direct interaction. The wearable audio device detects a material obstruction between the direct interaction, and in response applies an audio compensation to the speaker that adjusts an audio response of the speaker based at least in part on the baseline audio response.

### BACKGROUND

Wearable audio devices, including artificial intelligence (AI) enhanced devices, have gained popularity for hands-free communication and personal assistance. These devices often incorporate speakers and microphones to enable audio interactions. However, when attached to or worn under clothing, audio quality can be affected by material obstructing the sound path. Conventional wearable systems may encounter challenges maintaining consistent sound quality across different clothing types and thicknesses. Additionally, varying environmental noise levels impact a user ability to hear audio output clearly.

### BRIEF DESCRIPTION OF THE DRAWINGS

Aspects of wearable audio device material compensation are described with reference to the following figures. The same numbers may be used throughout to reference similar features and components that are shown in the figures. Further, identical numbers followed by different letters reference different instances of features and components described herein.

FIG. 1 illustrates an example environment in which aspects of wearable audio device material compensation can be implemented in accordance with one or more implementations.

FIG. 2 depicts a block diagram of an example wearable system that can be implemented for wearable audio device material compensation in accordance with one or more implementations.

FIG. 3 illustrates a flow chart depicting an example process for wearable audio device material compensation in accordance with one or more implementations.

FIGS. 4a through 4d illustrate show various views of a wearable audio device with material separation, in accordance with one or more implementations.

FIG. 5 illustrates a flow chart depicting an example process for wearable audio device material compensation in accordance with one or more implementations.

FIG. 6 illustrates various components of an example device in which aspects wearable audio device material compensation can be implemented in accordance with one or more implementations.

### DETAILED DESCRIPTION

Wearable audio device material compensation techniques address challenges of maintaining consistent sound quality when devices are covered by a material (e.g., clothing) or exposed to varying environmental conditions. These techniques enable dynamic audio adaptation to improve clarity and audibility of signals emitted from behind material obstructions and within noisy environments.

A wearable audio device includes a main body with a microphone array and a detachable speaker accessory. These separate physical components are configured to attach through material (e.g., clothing, luggage, backpacks, purses, bags, or other material worn on or near a user body), with the main body worn outside and the speaker accessory inside. An attachment feature, such as a magnetic mechanism, affixes the device to material by securing the material between the two parts. This allows the speaker accessory to be worn discreetly under clothing, under a strap, inside a pocket, while maintaining functionality with the main body worn over the clothing, over the strap, or outside the pocket. While implementations are discussed herein in the context of the physical components being attachable through clothing, it is to be appreciated that the described and claimed implementations can apply in a variety of different scenarios alternatively or additionally to attachment through materials other than clothing. Other non-limiting example scenarios including attachments through luggage or backpack materials (e.g., compartment walls and straps), in addition to items made from multiple materials (e.g., fabric, carbon fiber, fiber glass, plastic, metal, wood), such as the multiple safety layers that form protective gear for first responders, line workers, militaries, and astronauts.

The device is initialized by measuring a baseline audio response when the components are arranged to interact directly, e.g., when placed in direct physical contact or positioned in close proximity such that no obstructions are in between the two parts. For example, the baseline audio response is measured when the main body and the speaker accessory are directly interacting (e.g., in direct contact or where the only material separating the main body and the speaker accessory is air). When attached through an intervening material (e.g., clothing), the main body and the speaker accessory indirectly interact through the intervening material. The device determines whether a speaker obstruction occurs by comparing a current audio response to the previously measured baseline. Upon detecting an indirect interaction with the speaker accessory through the intervening clothing material, the main body initiates a test signal output from the speaker accessory. The microphone array on the main body measures the current audio response, and the device determines an audio compensation to apply, which improves the current audio response towards the baseline audio response. The audio compensation may involve adjusting frequency response, equalization, sound pressure level, output volume, or other audio parameters to reduce a difference between the baseline and modified responses.

Dynamic compensation of speaker outputs occurs automatically to maintain audibility in changing conditions. In aspects, an artificial intelligence model of the wearable audio device (e.g., a neural network, a large language model) analyzes environmental sounds and adjusts speaker volume or other speaker parameters to further compensate for varying noise levels and additional or different material obstructions. For example, the AI model is configured as an AI assistant and part of the assistive capability is to automatically control sound quality by employing the audio material compensation techniques. In aspects, the device may measure the distance between the speaker and microphone to refine compensation based on an inferred material thickness, including obstructions over the microphone. The attachment feature may include sensors to measure the separation distance between components. The artificial intelligence model may employ machine learning algorithms to adapt to different types of materials and material thicknesses over time.

This adaptive approach enhances the usability and effectiveness of wearable audio devices in real-world applications. By dynamically adjusting to material obstructions and ambient noise, the device ensures clear and consistent audio output across diverse wearing scenarios and environments.

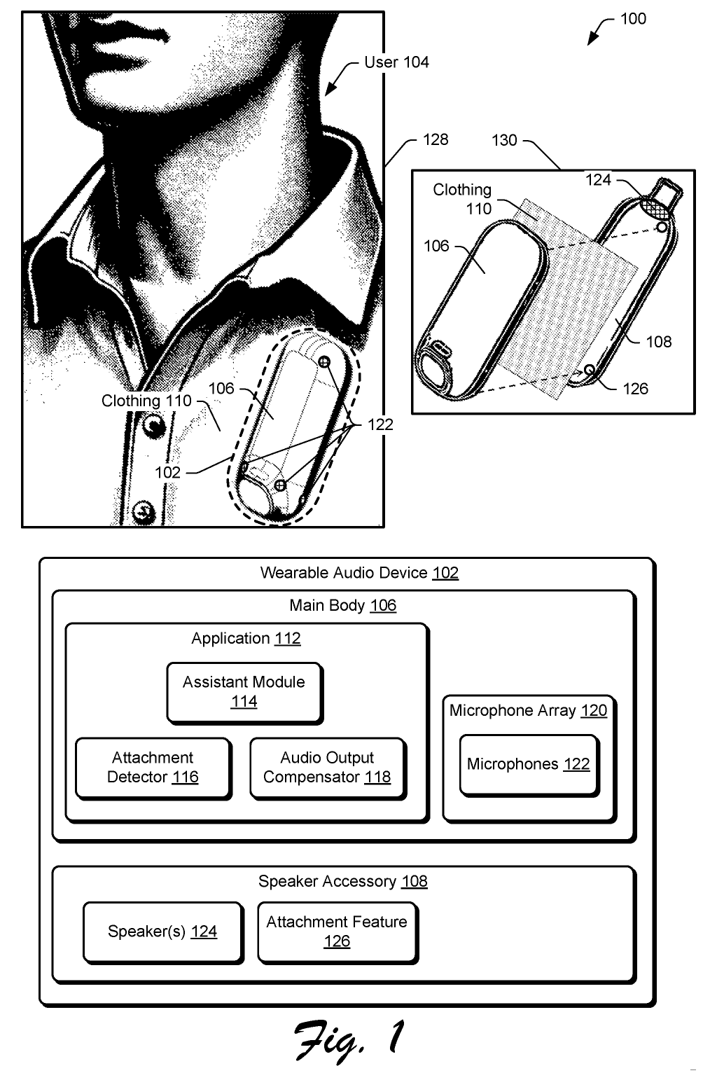

FIG. 1 illustrates an example environment 100 in which aspects of wearable audio device material compensation can be implemented. The environment 100 includes a wearable audio device 102 worn by a user 104, who is using the device while wearing clothing 110. The wearable audio device 102 comprises a main body 106 and a speaker accessory 108, which can be separated by the clothing 110. A perspective view 128 shows the device 102 worn by the user 104 on the clothing 110. An exploded view 130 shows the device 102 in greater detail.

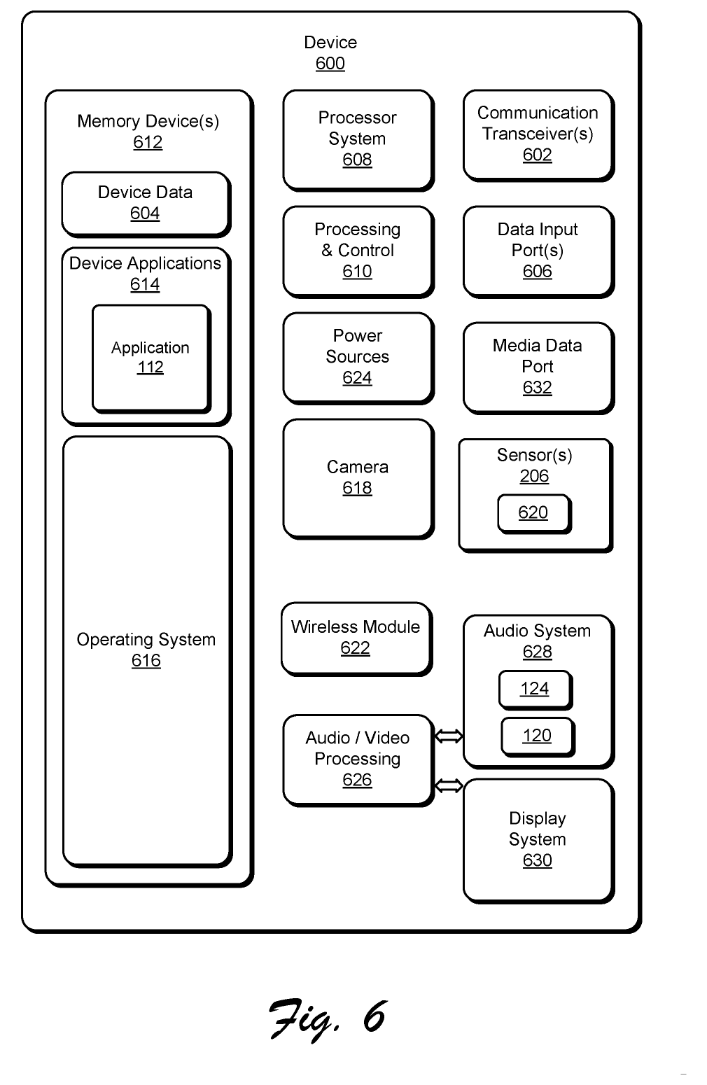

The wearable audio device 102 represents a device capable of audio output and compensation, such as a wearable AI assistant, a smart pin, or a clip-on audio device. The wearable audio device 102 can include various components, such as a processor system, memory, as well as any number and combination of different components as further described with reference to the example device 600 shown in FIG. 6. For example, the wearable audio device 102 may include sensors, cameras, displays, and wireless communication capabilities to enable a range of interactive and assistive functions.

The wearable audio device 102 includes an application 112 that implements audio compensation functionality. The application 112 is implemented as a software module executed by the processor system and stored in the memory of the wearable audio device 102. The application 112 integrates with the device's operating system to access hardware components and process audio signals. The application 112 may utilize machine learning algorithms to adapt to different types of materials and material thicknesses over time, improving compensation accuracy.

The application 112 contains several sub-modules. The assistant module 114 provides AI-driven functionality and user interaction capabilities. The attachment detector 116 detects an interaction (e.g., a direct interaction such as a physical connection or an indirect interaction through an intervening material) between the main body 106 and the speaker accessory 108, and the audio output compensator 118 processes audio signals and applies compensation based on detected obstructions.

The main body 106 includes a microphone array 120 containing multiple microphones 122 used to capture audio signals, including baseline and modified responses from the speaker accessory 108. The microphone array 120 enables accurate measurement of audio characteristics for compensation calculations. For instance, the microphone array 120 may use beamforming techniques to isolate and analyze the audio output from the speaker accessory 108, even in noisy environments. Examples of microphones 122 may include miniature MEMS microphones, electret condenser microphones, or dynamic microphones. The microphone array 120 may be configured in various arrangements, such as a linear array, circular array, or 3D array, depending on the desired spatial audio capture capabilities. For example, a circular array of 8 MEMS microphones could be used to provide 360-degree sound capture, while a linear array of 4 electret condenser microphones might be suitable for directional audio pickup.

The speaker accessory 108 contains at least one speaker 124 for audio output. For ease of description, the speaker 124 is referred to throughout as a single speaker, however, the speaker 124 can include more than one speaker and includes a plurality of speakers in variations. The speaker 124 is designed to function effectively when separated from the main body 106 by material , such as the clothing 110. Examples of materials include fabrics, carbon fiber, fiber glass, metal, wood, plastics, and other materials that form objects worn on or positioned near a user (e.g., worn on the clothing 110, attached to a backpack, etc.). Examples of speaker 124 may include dynamic drivers, balanced armature drivers, planar magnetic drivers, or electrostatic drivers. The attachment feature 126 allows the speaker accessory 108 to connect to the main body 106, potentially using a magnetic mechanism. The attachment feature 126 may incorporate sensors to measure the distance between the main body 106 and speaker accessory 108, providing additional data for audio compensation calculations. For instance, the sensors could include Hall effect sensors, optical sensors, or capacitive sensors to precisely measure the separation distance.

In operation, the attachment detector 116 recognizes when the speaker accessory 108 establishes an interaction (e.g., a direct interaction such as a physical connection or an indirect interaction through an intervening material) using the attachment feature 126 with the main body 106. Upon detecting this interaction, the attachment detector 116 initiates a series of actions to assess audio characteristics of the speaker 124. For example, the attachment detector 116 triggers the microphone array 120 to capture audio signals from the speaker accessory 108, enabling a baseline measurement of the audio response when a direct interaction is between them, without any intervening material obstructing the speaker accessory 108. This baseline measurement serves as a reference point for subsequent audio adjustments.

The attachment detector 116 can measure the distance between the main body 106 and the speaker accessory 108 using sensors embedded within the attachment feature 126 or through timing and delay analysis of audio signal characteristics. This distance information is used by the audio output compensator 118 to fine-tune audio compensation algorithms, with greater separation distances potentially requiring more aggressive equalization, sound pressure level, and output volume to compensate for high-frequency attenuation through thicker material layers that support the attachment feature 126, such as different compensations for different types of indirect interactions, such as attachments through a shirt, multiple protective layers of a utility vest for a police officer, a thick winter coat that dampens sounds emanating from the speaker 124 worn inside the coat, and the like.

The audio output compensator 118 adjusts frequency response, equalization, sound pressure and output volume levels of the speaker 124 to counteract attenuation caused by material. The audio output compensator 118 enhances certain frequency ranges more heavily dampened by fabric, such as higher frequencies. The audio output compensator 118 also performs dynamic range compression to improve audibility of quieter sounds emanating from the speaker 124 through the clothing 110. Additionally, the audio output compensator 118 analyzes spectral characteristics of the modified response, applies inverse filtering to adjust and if possible, match the baseline frequency response measured without the clothing 110 or other intervening material obstructing a direct interaction between the main body 106 and the speaker accessory 108. The audio output compensator 118 may adjust phase and timing of audio signals to account for delays introduced by variations in the clothing 110 or material supporting the attachment feature 126.

The audio output compensator 118 measures the baseline audio response using the microphone array 120 when the interaction between the main body 106 and the speaker accessory 108 is direct. When the clothing 110 or other material(s) obstructs the direct interaction, an indirection between the main body 106 and the speaker accessory 108 occur. The audio output compensator 118 measures a modified response from the speaker 124 and calculates compensations. The audio output compensator 118 causes the speaker 124 to generate test tones or impulse responses to characterize the acoustic properties of the intervening material, e.g., fabric of the clothing 110. The audio output compensator 118 calculates compensations directly, in some examples. In other examples, the assistant module 114 performs calculations or recommends a compensation applied by the audio output compensator 118.

The assistant module 114 implements artificial intelligence capabilities for the wearable audio device 102. The assistant module 114 analyzes environmental factors such as ambient noise levels captured by the microphone array 120 and adapts the audio compensation applied by the audio output compensator 118. For example, the assistant module 114 may instruct the audio output compensator 118 to adjust equalization parameters of the speaker 124 to enhance speech intelligibility when high ambient noise is detected. The assistant module 114 can also apply dynamic range compression to the audio output to improve audibility in noisy environments. The assistant module 114 may employ AI noise reduction techniques to further improve audio clarity in challenging acoustic environments.

An artificial intelligence model (e.g., a neural network) within the assistant module 114 enables continuous learning and optimization of these audio adaptations over time as the assistant module 114 encounters different environmental conditions. The assistant module 114 interfaces with other components like the attachment detector 116 to obtain contextual information about the device state and wearing configuration. This allows the assistant module 114 to tailor its audio compensation strategies for the audio output compensator 118 based on factors like whether material is obstructing the speaker 124. To address varying material thicknesses, the assistant module 114 and/or the audio output compensator 118 may employ machine learning algorithms to recognize and compensate for different types of fabric obstructions, ensuring consistent audio quality across various materials and material thicknesses. The application 112 may build a database of frequency response profiles for common material (e.g., various fabrics or clothing types, specific materials associated with other items besides clothing that support the attachment feature 126), allowing for automatic adaptation to varying wearing and attachment scenarios.

In operation, the user 104 may attach the main body 106 to the exterior of their clothing 110 and connect the speaker accessory 108 underneath through the fabric using the magnetic attachment feature 126. The attachment detector 116 initiates a baseline audio response measurement using the microphone array 120 when the components are directly connected, e.g., components are in direct contact when one component directly contacts another component. As the user 104 goes about their day, the device 102 continuously monitors for changes in the interaction state, e.g., whether a direct interaction or an indirect interaction of varying type exists between the main body 106 and the speaker accessory 108. When the clothing 110 is an intervening material that obstructs the interaction, the audio output compensator 118 measures a new audio response by initiating a test signal from the speaker 124, compares the new audio response to the stored baseline, and applies appropriate audio compensation. Throughout various environments, the assistant module 114 analyzes ambient noise levels and adjusts the audio output accordingly. The artificial intelligence model adapts the speaker parameters to maintain consistent audio quality across different settings. The device 102 may also account for varying material thicknesses by measuring the distance between components and refining the compensation. This adaptive process occurs automatically and continuously, ensuring that the user 104 experiences clear and consistent audio output across diverse wearing scenarios and environments. The wearable audio device 102 thus provides a seamless and enhanced audio experience, compensating for both material obstructions and environmental noise without requiring manual intervention from the user 104.

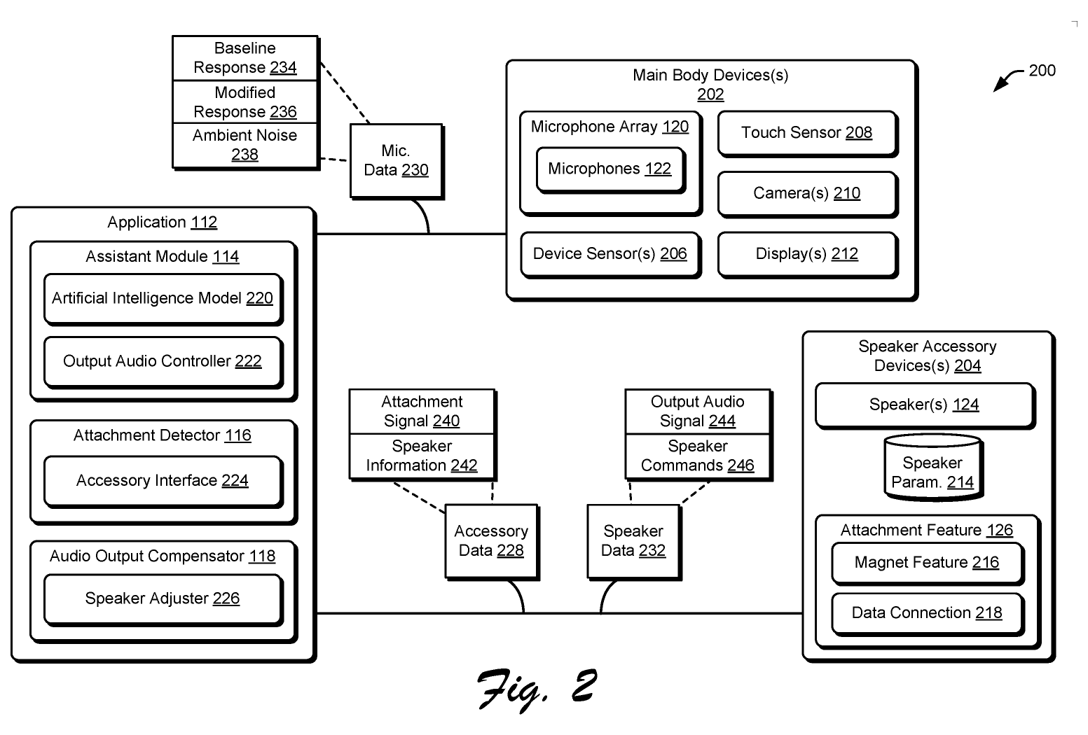

FIG. 2 depicts a block diagram of an example wearable system 200 that can be implemented for wearable audio device material compensation. The system 200 is described in the context of the environment 100 and is implemented on the wearable audio device 102 using similarly labeled elements as FIG. 1. The system 200 is implemented using a processing system and a memory system configured to execute instructions to implement the application 112, the assistant module 114, the attachment detector 116, the audio output compensator 118, and components thereof.

The wearable system 200 includes main body devices 202 and speaker accessory devices 204. The main body devices 202 include a microphone array 120 containing multiple microphones 122. The microphone array 120 employs beamforming techniques to isolate and analyze audio output from the speaker accessory 108, even in noisy environments. These microphones 122 may be arranged in linear, circular, or 3D array configurations.

Additional components within the main body devices 202 include device sensors 206, a touch sensor 208, cameras 210, and displays 212. These elements enhance the input-output capabilities of the system 200 and provide contextual information. For instance, the touch sensor 208 detects user interactions, while the cameras 210 may visually analyze material obstructing the speaker 124.

The speaker accessory devices 204 comprise speaker 124 and associated speaker parameters 214. The speaker 124 may be dynamic drivers, balanced armature drivers, planar magnetic drivers, or electrostatic drivers, designed to function effectively when separated from the main body 106 by the clothing 110, or other material in other attachment scenarios obstructing the speaker accessory devices 204. The speaker parameters 214 store information about speaker characteristics, including frequency response curves, impedance values, power handling capabilities, sound pressure levels, output volume levels, and sensitivity ratings. These can be controlled or adjusted through the speaker commands 246 from the speaker adjuster 226 to modify how the speaker 124 responds to the audio output compensator 118, e.g., to control the output audio signal 244.

An attachment feature 126 enables an interaction between the main body devices 202 and speaker accessory devices 204. This interaction can be a direct interaction or an indirect interaction. The attachment feature 126 supports a direct interaction in variations by establishing a physical contact or short separation distance between them, e.g., using a magnet feature 216 to connect them without an intervening material. The interaction is an indirect interaction when the attachment feature 126 secures the main body devices 202 to the speaker accessory devices 204 through an intervening material (e.g., the clothing 110), without establishing a direct interaction with the magnet feature 216. For example, the magnetic feature 216 forms an indirect interaction by attaching to a metal housing of the main body devices 202. A data connection 218 of the attachment feature 126 allows for communication between the main body devices 202 and the speaker accessory devices 204, enabling the exchange of audio signals and control information. This feature facilitates communication between components and may incorporate sensors to measure the separation distance. The attachment feature 126 may incorporate sensors to measure the distance between the main body 106 and speaker accessory 108, providing additional data through the data connection 218 for audio compensation calculations.

The application 112, for instance is implemented as a software module, orchestrates the system 200's operations. The application 112 may integrate with an operating system to access hardware components, including the speaker 124 and the microphones 122, and process audio signals.

The assistant module 114 implements artificial intelligence capabilities, analyzing environmental factors and adapting audio compensation strategies. An artificial intelligence model 220 enables continuous learning and optimization of audio adaptations. The assistant module 114 analyzes environmental factors such as ambient noise 238 captured by the microphone array 120 and adapts an audio compensation applied by the audio output compensator 118 as defined by speaker commands 246. For example, the assistant module 114 may instruct the audio output compensator 118 to adjust equalization parameters of the speaker 124 to enhance speech intelligibility when elevated ambient noise is detected. The assistant module 114 can also apply dynamic range compression to the audio output to improve audibility in noisy environments using the speaker adjuster 226. The assistant module 114 may employ AI noise reduction techniques through the speaker adjuster 226 to further improve audio clarity in challenging acoustic environments by changing the speaker parameters 214 through issuance of the speaker commands 246.

An artificial intelligence model 220 (e.g., a neural network, a large language model, a generative AI model) within the assistant module 114 enables continuous learning and optimization of audio adaptations over time as the model encounters different environmental conditions. The artificial intelligence model 220 interfaces with other components like the attachment detector 116 to obtain contextual information about the device state and wearing configuration. This allows the assistant module 114 to tailor audio compensation strategies for the audio output compensator 118 based on factors like whether material is obstructing the speaker 124. To address varying material thicknesses, the artificial intelligence model 220 may employ machine learning algorithms to recognize and compensate for different types of material obstructions (e.g., different fabrics, composites, finishes, metals, woods, plastics), ensuring consistent audio quality across various types of items (e.g., clothing, luggage, protective gear) made from various types of materials and of varying thicknesses. For example, the model may learn to apply more aggressive equalization for thick wool sweaters compared to thin cotton shirts. The application 112 may cause the artificial intelligence model 220 to build a database of frequency response profiles for common material types, allowing for dynamic adaptation to new wearing scenarios. This database for instance includes profiles for materials like denim, silk, polyester, and leather, each with characteristic attenuation patterns across the frequency spectrum. The artificial intelligence model 220 may also incorporate real-world usage data, such as recognizing that a user frequently wears the device with a particular jacket and automatically applying the appropriate compensation when that wearing configuration is detected.

The attachment detector 116 interfaces with the attachment feature 126, identifying direct and indirect interactions between the main body 106 and speaker accessory 108 and initiating the audio compensation process. The attachment detector 116 is implemented as a hardware and software component that interfaces with the attachment feature 126. This detector identifies the interaction between the main body 106 and the speaker accessory 108, initiating the audio compensation process when an indirect interaction through intervening material is established. The attachment detector 116 can measure the distance between the main body 106 and the speaker accessory 108 in various ways, such as using sensors embedded within the attachment feature 126 or through timing and delay analysis of audio signal characteristics. This distance information, which may arrive through the accessory interface 224, is used by the audio output compensator 118 to fine-tune audio compensation algorithms, with greater separation distances potentially requiring more aggressive equalization to compensate for high-frequency attenuation through thicker material layers.

The audio output compensator 118 adjusts speaker parameters to counteract attenuation caused by material. The audio output compensator 118 enhances frequency ranges dampened by fabric, performs dynamic range compression, and applies inverse filtering to adjust the frequency response to match a baseline established from a direct interaction. The audio output compensator 118 is implemented as a signal processing module within the application 112. The audio output compensator 118 adjusts the speaker parameters 214 (e.g., frequency response, equalization, sound pressure levels, and output volume levels) of the speaker 124 to counteract attenuation caused by clothing 110. The audio output compensator 118 enhances certain frequency ranges more heavily dampened by fabric, such as higher frequencies. The audio output compensator 118 also performs dynamic range compression to improve audibility of quieter sounds emanating from the speaker 124 through the clothing 110. Additionally, the audio output compensator 118 analyzes spectral characteristics of the modified response 236, applies inverse filtering to adjust and match the frequency response to a baseline established without the intervening clothing 110, and adjusts phase and timing of audio signals to account for delays introduced by the clothing 110 material.

The speaker adjuster 226, part of the audio output compensator 118, fine-tunes speaker output based on calculated compensations. A speaker adjuster 226 of the audio output compensator 118 communicates speaker data 232 including the speaker commands 246 indicating changes to the speaker parameters 214 of the speaker 124 to apply the compensation to the speaker accessory devices 204.

An output audio controller 222 manages the final audio output, implementing dynamic volume adjustments and other real-time modifications. An audio output controller 222 interfaces with the audio output compensator 118 to cause adjustments derived by the assistant module 114 to update the speaker parameters 214. This component is responsible for directing dynamic volume adjustments and other real-time audio modifications implemented by the speaker adjuster 226, for example.

The accessory interface 224 manages communication between the main body 106 and speaker accessory 108, ensuring seamless integration. This interface 224 handles the exchange of accessory data 228, including the attachment signal 240 and speaker information 242.

Data may flow continuously through the system 200, with microphone data 230, accessory data 228, and speaker data 232 moving between the main body devices 202, the application 112, and the speaker accessory devices 204. The microphone data 230 includes baseline response 234, modified response 236, and ambient noise 238 information. The accessory data 228 comprises attachment signal 240 and speaker information 242. The speaker data 232 contains output audio signal 244 and speaker commands 246.

This data is processed by various components within the application 112. The assistant module 114 and its artificial intelligence model 220 analyze environmental factors and device state to tailor compensation strategies. The attachment detector 116 uses the attachment signal 240 to initiate compensation processes. The accessory interface 224 manages the exchange of accessory data 228. The audio output compensator 118 and speaker adjuster 226 utilize this information to calculate and apply appropriate compensations, issuing speaker commands 246 to modify speaker parameters 214.

The system 200 repeatedly cycles, in some implementations, through measuring audio responses, calculating compensations, and applying adjustments. This ensures that the audio output remains consistent and clear, regardless of changes in material obstruction or environmental conditions. The system 200 may implement hysteresis in the compensation algorithms to prevent rapid oscillations in audio settings during sudden changes in environmental conditions or device attachment states. This adaptive approach ensures consistent audio quality across various materials, thicknesses, and environmental conditions, enhancing the overall user experience of the wearable audio device 102.

For example, to improve audio quality through thick material , the frequency response curve may be boosted in the mid and high ranges to counteract attenuation, while the overall output level is increased. In a thin material but noisy ambient situation, the speaker adjuster 226 may increase dynamic range compression to improve intelligibility, while also applying noise-dependent volume scaling to maintain audibility above the ambient noise 238 floor. For example, the attachment signal 240 indicates a distance measured between the microphones 122 and the speaker 124, which the assistant module 114 and the audio output compensator 118 use to generate appropriate speaker commands 246 to improve the output audio signal 244. This additional sensory information can be used by the artificial intelligence model 220 to further refine audio compensation strategies.

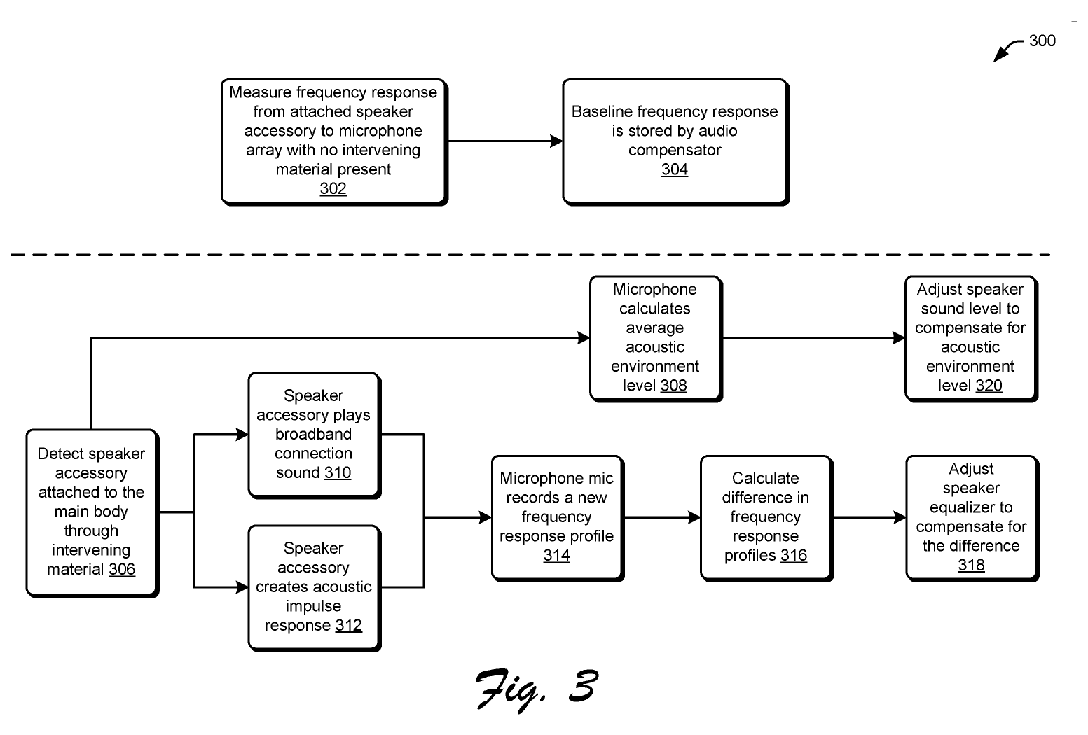

FIG. 3 illustrates a flow chart depicting an example process 300 for wearable audio device material compensation in accordance with one or more implementations. The process 300 may be performed in the context of the environment 100, such as by the mobile device 102 and/or the system 200.

At step 302, the process 300 measures a frequency response from an attached speaker accessory to a microphone array with no intervening material present. The microphone array 120 of the main body 106 captures the baseline audio response 234 from the speaker 124 of the speaker accessory 108 when directly connected. This establishes a reference point for subsequent comparisons.

At step 304, the baseline frequency response is stored by an audio compensator. The audio output compensator 118 saves this baseline response 234 in memory for later use in calculating audio adjustments implemented by the speaker adjuster 226.

At step 306, a speaker accessory attached to the main body through intervening material is detected. The attachment detector 116 recognizes when the speaker accessory 108 connects to the main body 106 through clothing 110, triggering the subsequent compensation process. The step 306 may include measuring a distance between the main body 106 and speaker accessory 108 using sensors in the attachment feature 126. This distance information can be used to refine the audio compensation at steps 318 and 320. In some examples, an electric or magnetic connection is wirelessly established through the material (e.g., using a wireless communication or sensor data interface established within the data connection 218 of the attachment feature 126 and the accessory interface 224). For example, short range wireless transceivers on the main body 106 communicate with corresponding transceivers on the speaker accessory 108 to detect and establish an attachment or connection through the clothing 110.

At step 308, the microphone calculates average acoustic environment level. The microphone array 120 measures ambient noise 238 to factor environmental conditions into the compensation calculations.

At step 310, the speaker accessory plays a broadband connection sound. The speaker 124 emits a test signal covering a wide frequency range to assess audio transmission through the clothing 110.

At step 312, the speaker accessory creates an acoustic impulse response. This provides additional data on how the clothing 110 affects sound propagation across different frequencies.

At step 314, the microphone records a new frequency response profile. The microphone array 120 captures the modified response 236 from the speaker 124 through the clothing 110.

At step 316, the process 300 calculates differences in frequency response profiles. The audio output compensator 118 compares the modified response 236 to the stored baseline response 234 to determine how the clothing 110 alters the audio characteristics.

At step 318, the speaker equalizer is adjusted to compensate for the difference. The speaker adjuster 226 modifies speaker parameters 214 to counteract the attenuation and frequency changes caused by the clothing 110.

At step 320, the speaker sound level is adjusted to compensate for the acoustic environment level. The speaker adjuster 226 further modifies the output audio signal 244 based on the ambient noise 238 measured in step 308, ensuring audibility in varying environmental conditions. An artificial intelligence model 220 to analyze environmental factors and adapt the audio compensation. The model can learn to recognize different types of materials and thicknesses over time, improving compensation accuracy.

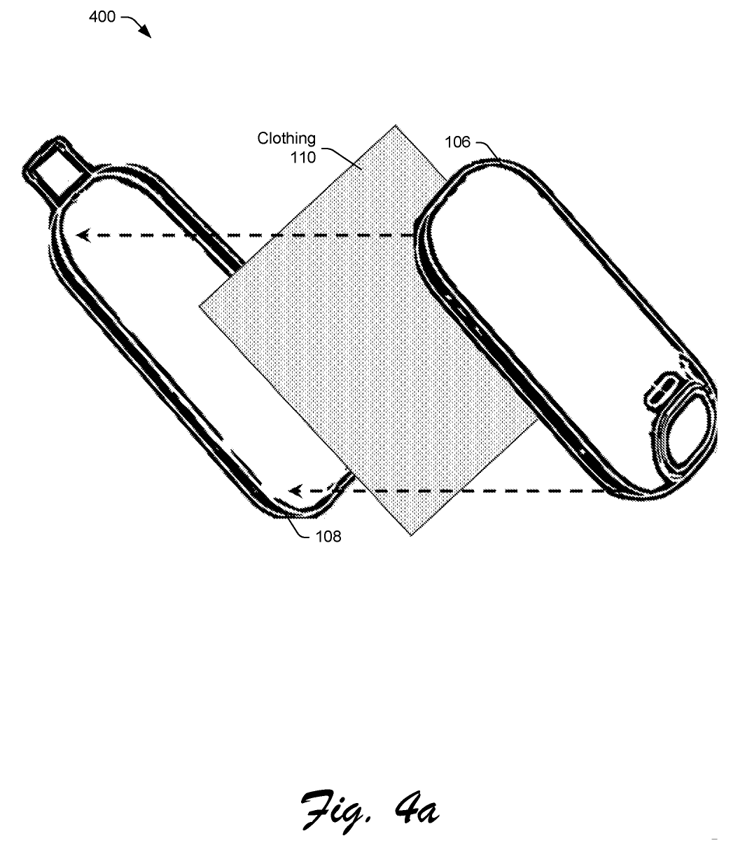

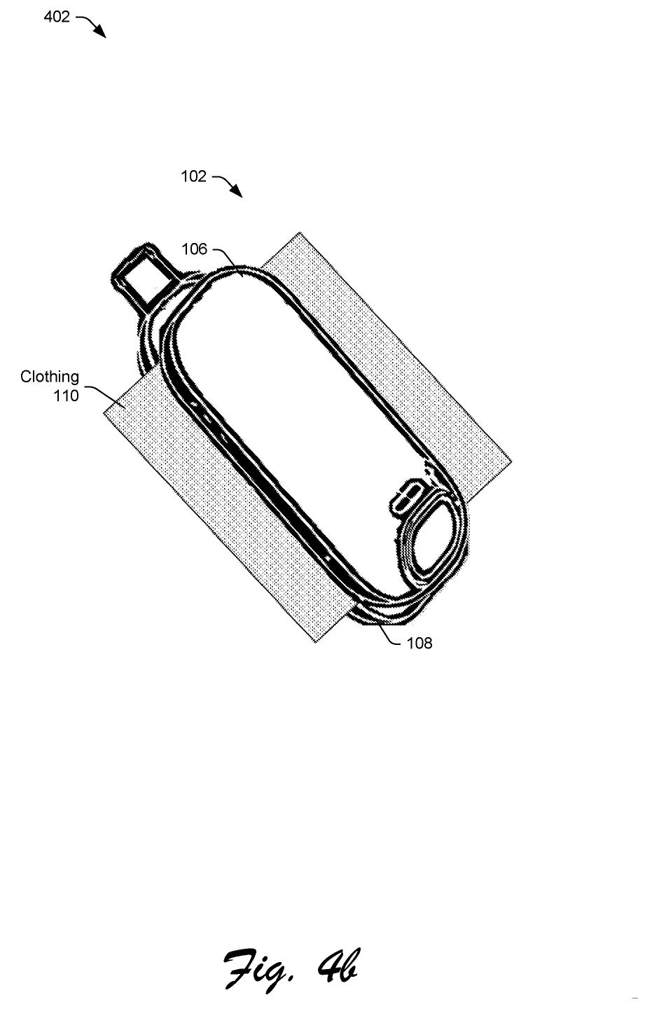

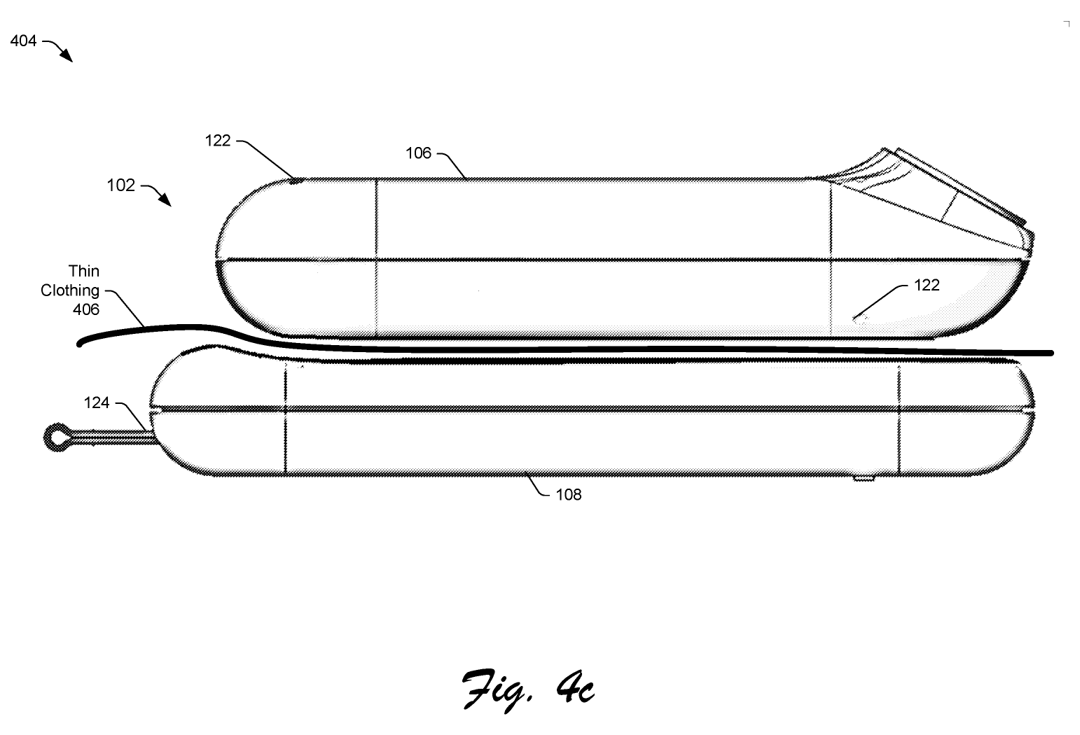

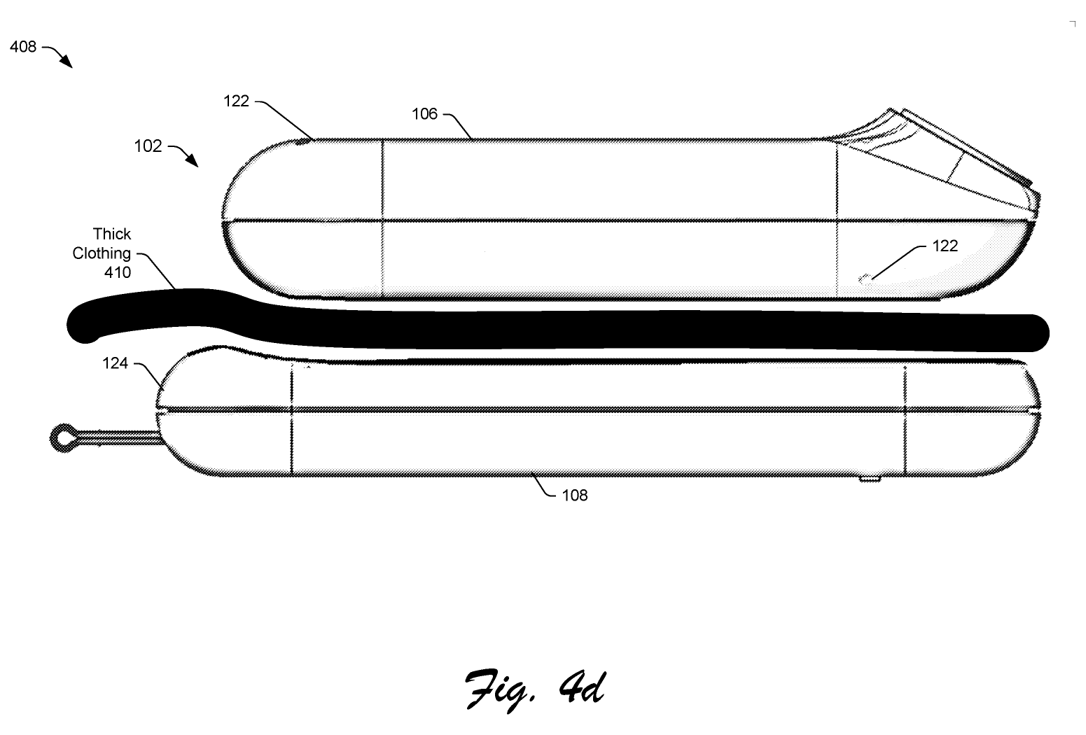

FIGS. 4a through 4d illustrate various views of a wearable audio device with material separation. Each of the FIGS. 4a through 4d is described in the context of the environment 100 and the wearable audio device 102.

FIG. 4a shows an exploded view 400 depicting the spatial relationship between a main body 106, clothing 110, and a speaker accessory 108. The main body 106 is positioned on one side of the clothing 110, while the speaker accessory 108 is positioned on the opposite side. The components are arranged to be magnetically attachable through the clothing 110. The clothing 110 is one example of material or situation where the main body 106 is worn outside and the speaker accessory 108 is worn inside. As explained throughout, various attachment material(s) on various items may support the attachment feature 126 and apply the described techniques.

FIG. 4b presents an operational view 402 of the wearable audio device 102 with the main body 106 and speaker accessory 108 separated by clothing 110. The main body 106 is shown indirectly contacting the speaker accessory 108 through the clothing 110. This configuration allows the main body 106 to be visible on the clothing exterior while the speaker accessory 108 remains concealed beneath. When the process 300 detects the configuration in step 306, the process 300 proceeds to measure the audio response through the clothing obstruction in step 314. The audio output compensator 118 then determines appropriate compensation in step 316 based on the measured response compared to the baseline. Finally, in step 318, the compensation is applied to adjust the speaker output and maintain audio quality despite the clothing barrier.

FIG. 4c provides a side view 404 illustrating the main body 106 and speaker accessory 108 separated by thin clothing material 406. The magnetic connection between the components is maintained through the fabric layer. When the clothing is thin, the audio output compensator 118 may apply less aggressive equalization to compensate for frequency attenuation. The attachment detector 116 can measure the precise separation distance between components to refine compensation algorithms. The artificial intelligence model 220 may analyze spectral characteristics of audio transmitted through thin fabrics to optimize speaker parameters 214 for improved clarity and fidelity. Additionally, the assistant module 114 can adapt volume levels dynamically based on ambient noise detected through the microphone array 120, even with minimal clothing obstruction present.

FIG. 4d illustrates another side view 408 with the components separated by thick clothing 410. This configuration demonstrates how the device maintains functionality despite substantial fabric thickness between the main body 106 and speaker accessory 108. The audio output compensator 118 may apply more aggressive equalization and sound pressure level and output volume adjustments to compensate for greater attenuation through thicker materials. The attachment detector 116 can measure the increased separation distance to refine compensation algorithms. The artificial intelligence model 220 may analyze spectral characteristics of audio transmitted through thick fabrics to optimize speaker parameters 214 for improved clarity and audibility. Additionally, the assistant module 114 can adapt volume levels dynamically based on ambient noise detected through the microphone array 120, even with significant material obstruction present.

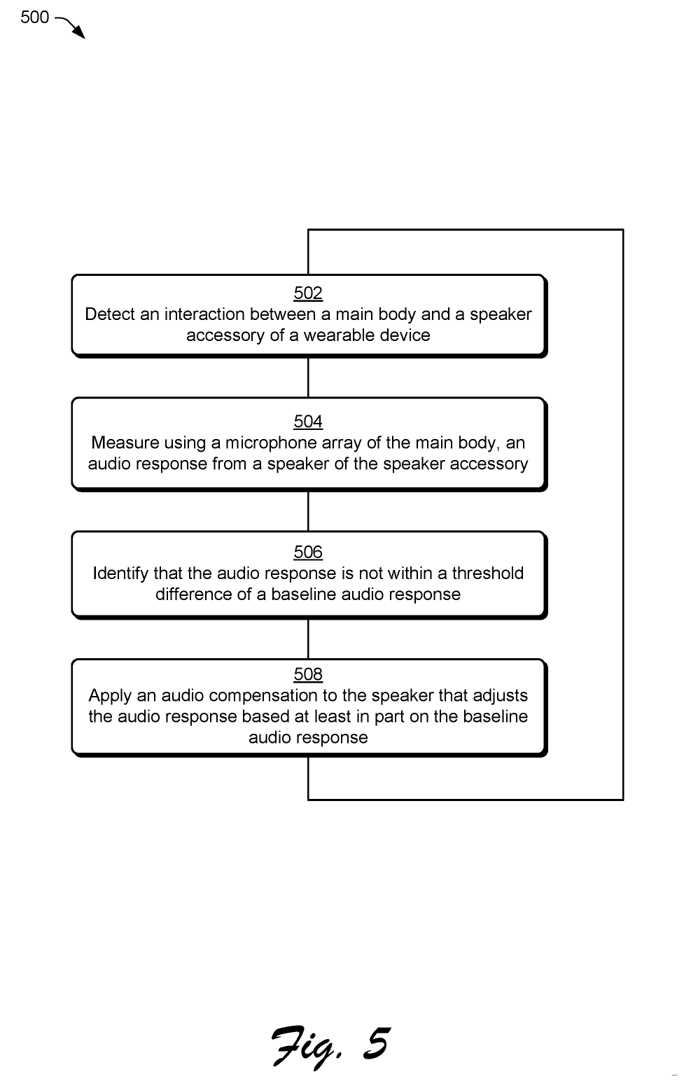

FIG. 5 illustrates a flow chart depicting an example process 500 for wearable audio device material compensation in accordance with one or more implementations. The process 500 may be performed in the context of the environment 100, such as by the mobile device 102 and/or the system 200.

At step 502, the process 500 detects an interaction between a main body and a speaker accessory of a wearable device. The attachment detector 116 recognizes when the speaker accessory 108 connects to the main body 106, e.g., through a direct interaction formed by close placement or contact between them, or an indirect interaction potentially formed through clothing 110 by establishing an indirect interaction, triggering the subsequent compensation process.

At step 504, responsive to detecting the interaction, the process 500 measures, using a microphone array of the main body, an audio response from a speaker of the speaker accessory. The microphone array 120 captures the audio output from the speaker 124 of the speaker accessory 108, which may be modified by any intervening material.

At step 506, the process 500 identifies when the audio response differs from a baseline audio response. The audio output compensator 118 compares the measured audio response to a previously stored baseline response 234 (e.g., measured when there is a direct interaction between the main body 106 and the speaker accessory 108 without any intervening material or other obstruction between them), determining if there are substantial differences that may be caused by material obstruction or other factors.

At step 508, the process 500 applies an audio compensation to the speaker that adjusts the audio response based at least in part on the baseline audio response. The speaker adjuster 226 modifies speaker parameters 214 to counteract any attenuation or frequency changes caused by material or other obstructions, aiming to restore the audio output to match the baseline response as closely as possible.

The process 500 may additionally incorporate analysis of environmental factors such as ambient noise levels. The assistant module 114 can adapt the audio compensation based on these environmental factors, potentially adjusting volume levels, or applying AI noise reduction techniques to improve audio clarity in varying conditions.

Furthermore, the process 500 may account for varying thicknesses of material between the speaker accessory and the main body. The attachment detector 116 can measure the distance between components, allowing the audio output compensator 118 to refine its compensation algorithms based on the thickness of the intervening material.

The process 500 represents a continuous cycle of measurement, analysis, and adjustment. By repeatedly performing these steps, the wearable audio device can maintain consistent audio quality across diverse wearing scenarios and environments, adapting to changes in material , ambient noise, and other factors that may affect audio output.

The process may be performed repeatedly or at regular intervals to adapt to changes in the obstruction or wearing conditions. Additionally, the audio compensation may be refined over time using the artificial intelligence model 220 to improve accuracy and effectiveness across different types of obstructions and environmental conditions. The assistant module 114 may analyze ambient noise levels and other contextual information to further optimize the audio compensation. The artificial intelligence model 220 may employ machine learning algorithms to recognize and compensate for different types of fabric obstructions, ensuring consistent audio quality across various materials and thicknesses. The application 112 may build a database of frequency response profiles for common material types, allowing for rapid adaptation to new wearing scenarios.The example processes, procedures, algorithms, and methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device 600 in which aspects of wearable audio device material compensation can be implemented. The device 600 can be implemented as any of the devices described with reference to the previous FIGS. 1-5, such as any type of mobile device, mobile phone, wearable device, tablet, computing device, communication device, entertainment device, gaming device, media playback device, and/or other type of electronic device. For example, aspects of the wearable audio device 102 and/or the system 200, as shown and described with reference to FIGS. 1-5 may be implemented as the example device 600.

The device 600 includes communication transceivers 602 that enable wired and/or wireless communication of device data 604 with other devices. The device data 604 can include device identifying data, device location data, wireless connectivity data, and wireless protocol data. Additionally, the device data 604 can include audio, video, and/or image data. The device data 604 can include communication data, such as radio measurements and radio messages. Example communication transceivers 602 include wireless personal area network (WPAN) radios compliant with various IEEE 802.15 (BluetoothTM) standards, wireless local area network (WLAN) radios compliant with any of the various IEEE 802.11 (Wi-FiTM) standards, wireless wide area network (WWAN) radios for cellular phone communication, wireless metropolitan area network (WMAN) radios compliant with various IEEE 802.16 (WiMAXTM) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory 612 can include various implementations of random access memory (RAM), read-only memory (ROM), flash memory, and other types of storage media in various memory device configurations. The device 600 may also include a mass storage media device. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

The computer-readable storage memory 612 provides data storage mechanisms to store the device data 604, other types of information and/or data, and various device applications 614 (e.g., software applications). The device applications 614 include the application 112, the attachment detector 116, and the audio output compensator 118, for instance. As another example of device programs maintained in the computer-readable storage memory 612 include instructions for an operating system 616. The operating system 616, for example, implements aspects of the application 112 to execute communications (e.g., audio calls, video calls, telephone calls, live streams). The instructions can be maintained as software instructions within the memory 612 and executed by the processing system 608. When executed, the instructions cause the processing system 608 to execute the device applications 614, which may also include a device manager, such as any form of a control application, software application, signal-processing and control module, code that is native to a particular device, a hardware abstraction layer for a particular device, and so on.

In this example, the example device 600 also includes a camera 618 and the device sensors 206, including motion sensors 620, such as may be implemented in an inertial measurement unit (IMU). The motion sensors 620 can be implemented with various sensors, such as the device sensors 206, for example, including a gyroscope, an accelerometer, and/or other types of motion sensors to sense motion of the device. The various motion sensors 620 may also be implemented as components of an inertial measurement unit in the device. The device 600 also includes a wireless module 622, which is representative of functionality to perform various wireless communication tasks, such as through a remote service accessed from a network connection established by the wireless module 622 to a network.

The device 600 can also include one or more power sources 624, such as when the device is implemented as a mobile device. The power sources 624 may include a charging and/or power system, and can be implemented as a flexible strip battery, a rechargeable battery, a charged super-capacitor, and/or any other type of active or passive power source.

The device 600 also includes an audio and/or video processing system 626 that generates audio data for an audio system 628 and/or generates display data for a display system 630. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 632. In implementations, the audio system and/or the display system are integrated components of the example device. Alternatively, the audio system and/or the display system are external, peripheral components to the example device.

Although implementations of wearable audio device material compensation have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a wearable audio device including: a main body having at least one microphone, a speaker accessory having a speaker and an attachment feature attachable to the main body, at least one memory device, and at least one processor coupled with the at least one memory device and operable to: obtain a baseline audio response of the speaker measured with the at least one microphone when the attachment feature directly interacts with the main body, responsive to detecting the speaker accessory indirectly interacting with the main body through an intervening material, use the at least one microphone to test an audio response of the speaker, and apply an audio compensation to the speaker to adjust the audio response based at least in part on the baseline audio response.

In some aspects, the techniques described herein relate to a wearable audio device, wherein the attachment feature includes a magnetic attachment.

In some aspects, the techniques described herein relate to a wearable audio device, wherein the at least one processor is further operable to: analyze environmental factors including ambient noise levels and adapt the audio compensation based on the environmental factors.

In some aspects, the techniques described herein relate to a wearable audio device, wherein the at least one processor is further operable to: dynamically adjust a volume of the speaker based on environmental noise.

In some aspects, the techniques described herein relate to a wearable audio device, wherein the at least one processor is further operable to: compensate for varying thicknesses of the intervening material between the speaker accessory and the main body.

In some aspects, the techniques described herein relate to a wearable audio device, wherein the at least one processor is further operable to: measure a distance between the speaker accessory and the main body and adjust the audio compensation based on the distance.

In some aspects, the techniques described herein relate to a wearable audio device, wherein the at least one processor is further operable to execute an artificial assistance model configured as an artificial assistant that responds to audio commands from a user by controlling the speaker.

In some aspects, the techniques described herein relate to a method, including: detecting an interaction between a main body and a speaker accessory of a wearable device, responsive to detecting the interaction, measuring an audio response from a speaker of the speaker accessory, identifying that the audio response differs from a baseline audio response, and applying an audio compensation to the speaker that adjusts the audio response based at least in part on the baseline audio response.

In some aspects, the techniques described herein relate to a method, further including: detecting a thicknesses of material between the speaker accessory and the main body and compensating for the thicknesses of the material between the speaker accessory and the main body.

In some aspects, the techniques described herein relate to a method, further including: measuring a distance between the speaker accessory and the main body and adjusting the audio compensation based on the distance.

In some aspects, the techniques described herein relate to a method, wherein the interaction includes a direct interaction forming a physical connection based on a magnetic attachment, or the interaction includes an indirect interaction forming the physical connection through an intervening material.

In some aspects, the techniques described herein relate to a method, wherein the main body further includes at least one of a camera or touch sensors.

In some aspects, the techniques described herein relate to a method, wherein the audio compensation includes adjusting audio characteristics of the speaker.

In some aspects, the techniques described herein relate to a method, further including: analyzing environmental factors including ambient noise levels, and adapting the audio compensation based on the environmental factors.

In some aspects, the techniques described herein relate to a method, further including: dynamically adjusting a volume of the speaker based on environmental noise.

In some aspects, the techniques described herein relate to a system including: at least one memory device, and at least one processor coupled with the at least one memory device and operable to: detect a direct interaction between a main body and a speaker accessory of a wearable device, measure a baseline audio response from a speaker of the speaker accessory in response to the direct interaction between the main body and the speaker accessory, store the baseline audio response, detect a material obstruction between the direct interaction, and responsive to detecting the material obstruction, apply an audio compensation to the speaker that adjusts an audio response of the speaker based at least in part on the baseline audio response.

In some aspects, the techniques described herein relate to a system, wherein the material obstruction includes clothing.

In some aspects, the techniques described herein relate to a system, wherein the at least one processor is further operable to: analyze environmental factors including ambient noise levels and adapt the audio compensation based on the environmental factors.

In some aspects, the techniques described herein relate to a system, wherein the at least one processor is further operable to: measure a distance between the speaker accessory and the main body and adjust the audio compensation based on the distance.

In some aspects, the techniques described herein relate to a system, wherein the at least one processor is further operable to: execute an artificial assistance model configured as an artificial assistant that responds to audio commands from a user by controlling the speaker.

What is claimed is:

1. A wearable audio device comprising:
a main body having at least one microphone;
a speaker accessory having a speaker and an attachment feature attachable to the main body;
at least one memory device; and
at least one processor coupled with the at least one memory device and operable to:
obtain a baseline audio response of the speaker measured with the at least one microphone when the attachment feature directly interacts with the main body;
responsive to detecting the speaker accessory indirectly interacting with the main body through an intervening material, use the at least one microphone to test an audio response of the speaker ; and
apply an audio compensation to the speaker to adjust the audio response based at least in part on the baseline audio response.

2. The wearable audio device of claim 1, wherein the attachment feature comprises a magnetic attachment.

3. The wearable audio device of claim 1, wherein the at least one processor is further operable to:
analyze environmental factors including ambient noise levels; and
adapt the audio compensation based on the environmental factors.

4. The wearable audio device of claim 1, wherein the at least one processor is further operable to:
dynamically adjust a volume of the speaker based on environmental noise.

5. The wearable audio device of claim 1, wherein the at least one processor is further operable to:
compensate for varying thicknesses of the intervening material between the speaker accessory and the main body.

6. The wearable audio device of claim 1, wherein the at least one processor is further operable to:
measure a distance between the speaker accessory and the main body; and
adjust the audio compensation based on the distance.

7. The wearable audio device of claim 1, wherein the at least one processor is further operable to execute an artificial assistance model configured as an artificial assistant that responds to audio commands from a user by controlling the speaker.

8. A method, comprising:
detecting an interaction between a main body and a speaker accessory of a wearable device;
responsive to detecting the interaction, measuring an audio response from a speaker of the speaker accessory;
identifying that the audio response differs from a baseline audio response; and
applying an audio compensation to the speaker that adjusts the audio response based at least in part on the baseline audio response.

9. The method of claim 8, further comprising:
detecting a thicknesses of material between the speaker accessory and the main body; and
compensating for the thicknesses of the material between the speaker accessory and the main body.

10. The method of claim 8, further comprising:
measuring a distance between the speaker accessory and the main body; and
adjusting the audio compensation based on the distance.

11. The method of claim 8, wherein the interaction includes a direct interaction forming a physical connection based on a magnetic attachment, or the interaction includes an indirect interaction forming the physical connection through an intervening material.

12. The method of claim 8, wherein the main body further comprises at least one of a camera or touch sensors.

13. The method of claim 8, wherein the audio compensation comprises adjusting audio characteristics of the speaker.

14. The method of claim 8, further comprising:
analyzing environmental factors including ambient noise levels; and
adapting the audio compensation based on the environmental factors.

15. The method of claim 8, further comprising:
dynamically adjusting a volume of the speaker based on environmental noise.

16. A system comprising:
at least one memory device; and
at least one processor coupled with the at least one memory device and operable to:
detect a direct interaction between a main body and a speaker accessory of a wearable device;
measure a baseline audio response from a speaker of the speaker accessory in response to the direct interaction between the main body and the speaker accessory;
store the baseline audio response;
detect a material obstruction between the direct interaction; and
responsive to detecting the material obstruction, apply an audio compensation to the speaker that adjusts an audio response of the speaker based at least in part on the baseline audio response.

17. The system of claim 16, wherein the material obstruction comprises clothing.

18. The system of claim 16, wherein the at least one processor is further operable to:
analyze environmental factors including ambient noise levels; and
adapt the audio compensation based on the environmental factors.

19. The system of claim 16, wherein the at least one processor is further operable to:
measure a distance between the speaker accessory and the main body; and
adjust the audio compensation based on the distance.

20. The system of claim 16, wherein the at least one processor is further operable to:
execute an artificial assistance model configured as an artificial assistant that responds to audio commands from a user by controlling the speaker.
